(19) United States
(12) Patent Application Publication
(10) Pub. No.: US 2026/0320560 A1
(43) Pub. Date: Oct. 15, 2026

(54) UNIFIED MEETINGS AND PROJECT MANAGEMENT SYSTEM (UMS)

(71) Applicant: Divakar Talagadadeevi, Frisco, TX (US)

(72) Inventor: Divakar Talagadadeevi, Frisco, TX (US)

(21) Appl. No.: 19/463,667

(22) Filed: Jan. 29, 2026

Related U.S. Application Data
(60) Provisional application No. 63/752,557, filed on Jan. 31, 2025.

(51) Int. Cl. G06Q 10/10; G06Q 10/109; G06Q 10/1093

(52) U.S. Cl. CPC G06Q 10/103; G06Q 10/1093; G06Q 10/1097

(57) ABSTRACT

A unified meetings governance system obtains meeting event data and meeting content from meeting sources and normalizes the data, using schema mapping and identifier resolution, into canonical meeting artifact objects stored in a centralized data store with lineage and audit metadata. When transcript data is available, an AI/NLP pipeline segments the transcript, detects candidate meeting-derived items, and applies confidence scoring to select items including minutes of meeting, decisions, action items, tasks, risks, issues, dependencies, and assumptions. Meetings, minutes documents, and execution items are managed under independent lifecycle state machines with closure conditions and immutable approved minute versions. Selective visibility designations signal importance without changing ownership. Role-based access control, tenant isolation, and optional redaction are applied when generating dashboards, exporting reports, and answering natural language governance queries with references to underlying records. Repetitive actions are maintained as persistent entities that generate execution cycles with monitoring, escalation, and risk linkage.

### CROSS-REFERENCE TO RELATED APPLICATIONS

This application claims the benefit of U.S. Provisional Patent Application No. 63/752,557, filed Jan. 31, 2025, the entire disclosure of which is incorporated herein by reference.

### FIELD OF THE INVENTION

This disclosure relates generally to computer-implemented enterprise collaboration, governance, and productivity management systems, and more particularly to systems and methods for end-to-end meeting lifecycle management and governance of meetings and meeting-derived artifacts within an organization.

In particular, this disclosure relates to centralized platforms and architectures for obtaining meeting data from heterogeneous meeting sources, transforming the data into canonical meeting artifacts, and storing meeting records with persistent lineage and audit metadata to support governance, analytics, and role-aware reasoning across meetings.

This disclosure further relates to artificial intelligence-assisted processing of meeting content, including natural language processing (NLP), automated transcription, summarization, classification, extraction of action items and other artifacts, confidence-based human review workflows, and generation of dashboards and insights that quantify meeting effectiveness, execution progress, and organizational performance.

This disclosure also relates to governance of repetitive or recurring organizational actions as persistent entities that generate discrete execution cycles with monitoring, escalation, and linkage to risks and issues for compliance and accountability.

### BACKGROUND OF THE INVENTION

Organizations across industries rely heavily on meetings as a primary mechanism for communication, coordination, decision-making, governance, and execution of work. Meetings are routinely conducted to share information, approve decisions, identify risks and issues, assign responsibilities, track progress, and align stakeholders across organizational hierarchies. As organizations grow in size and complexity, the number, frequency, and strategic importance of meetings correspondingly increase.

Despite their central role in organizational operations, meetings are commonly treated as isolated and transient events rather than as managed enterprise processes. In conventional practice, meetings are scheduled and conducted using disparate communication, calendaring, or collaboration tools, while meeting outputs such as minutes of meetings, decisions, action items, tasks, risks, issues, assumptions, and dependencies are manually recorded and distributed by individual organizers.

These meeting records are frequently shared through email, messaging applications, or decentralized document repositories, resulting in fragmented storage, inconsistent formats, limited traceability, and loss of institutional context across meetings, and reduced accountability for meeting outcomes.

Existing collaboration, conferencing, and content-management platforms primarily focus on facilitating communication or storing documents, but do not provide end-to-end lifecycle management of meetings as governed organizational entities. Such systems typically lack mechanisms to govern and manage meetings across defined lifecycle stages, including creation, scheduling, execution, review, follow-up, and formal closure, and fail to maintain persistent and structured relationships between meetings and their resulting execution artifacts.

As a result, organizations are often unable to reliably determine whether outcomes discussed in meetings are executed, delayed, abandoned, or remain unresolved. Meetings may remain open without formal closure, minutes of meetings may remain unpublished or unapproved, and action items, tasks, risks, and issues identified during meetings may lack ownership, accountability, or follow-up.

Furthermore, conventional tools do not provide organization-wide visibility or hierarchical oversight of meetings. Executive leadership and governance bodies generally lack centralized access to view all meetings occurring across an organization, analyze meeting volume or effectiveness, or assess how time spent in meetings translates into actionable outcomes. Department heads, managers, team leads, and individual contributors similarly lack consolidated and role-appropriate visibility into meetings conducted within their respective scopes.

In many organizations, minutes of meetings are treated as informal notes or static documents distributed via email or shared repositories, without standardized governance, approval workflows, or lifecycle tracking. As a result, it is often unclear which version of the minutes represents the authoritative record, whether the minutes have been reviewed or approved, or how subsequent changes relate to previously distributed versions. This lack of document-level governance for minutes of meetings further exacerbates accountability, auditability, and compliance challenges, particularly in organizations operating in regulated or high-governance environments.

Another limitation of existing approaches is the absence of structured analytics, auditability, and productivity measurement. Organizations are unable to reliably quantify time spent in meetings relative to execution of work, identify redundant or non-productive meetings, measure the effectiveness of meetings in driving decisions and results, or maintain auditable records of meeting decisions and commitments for governance or compliance purposes. Meeting data, when available, often remains unstructured and unsuitable for organization-level analysis, reporting, or oversight.

While recent advancements in artificial intelligence have enabled automated transcription and summarization of meetings, such capabilities are typically implemented as isolated features. These tools do not integrate transcription outputs into a centralized governance framework, do not normalize meeting records across heterogeneous meeting sources into a canonical representation for cross-meeting analysis, do not systematically extract or track risks, issues, or execution dependencies arising from meetings, and do not link extracted information to execution workflows, hierarchical dashboards, or lifecycle-based accountability mechanisms. Consequently, meeting intelligence remains disconnected from organizational decision-making, risk management, and performance management.

Accordingly, there exists a need for a computer-implemented system that treats meetings as governed organizational entities, provides centralized end-to-end meeting lifecycle management, maintains persistent linkages between meetings and execution artifacts, supports canonical transformation of meeting records for cross-meeting analytics and governance, enables hierarchical and role-based visibility and oversight, and delivers actionable analytics and insights that transform meetings into traceable, auditable, and productive enterprise records.

In organizational contexts where decisions, approvals, risks, issues, and commitments are discussed during meetings, the absence of centralized, governed, and auditable meeting management can increase operational, legal, compliance, and execution risks across multiple levels of the organization.

Existing enterprise collaboration, task management, and workflow systems predominantly treat action items as discrete, one-time execution items. While such action items may originate from meetings, policies, regulatory requirements, or operational processes, current systems fail to provide persistent, governance-oriented lifecycle management for repetitive or recurring organizational action items that span multiple execution cycles.

### SUMMARY OF THE INVENTION

In one aspect, the present disclosure provides a computer-implemented unified meetings and execution governance system that centrally manages meetings and meeting-derived information across an organization to support accountability, auditability, and decision support.

In some embodiments, the system obtains meeting event data and meeting content from one or more meeting sources including external meeting platforms, internal meeting platforms implemented within the system, calendaring systems, and organizational repositories, and stores meeting data in a centralized data store in association with a meeting identifier and one or more lifecycle states.

In some embodiments, the system includes a normalization engine that transforms heterogeneous meeting-source schemas into a canonical meeting artifact object by applying schema mapping, field alignment, data transformation operations, and identifier resolution and deduplication. The canonical meeting artifact object enables cross-meeting indexing, governance, and analytics across disparate meeting sources.

In some embodiments, each meeting is managed across defined lifecycle stages including creation, draft, scheduling, execution, review, publication, identification of unresolved outcomes, and formal closure, enabling traceability and accountability of meetings and their results.

In some embodiments, the system determines whether machine-readable meeting content for a meeting is available. When such content is available, the system processes the meeting content using one or more artificial intelligence models, including natural language processing (NLP), to identify one or more meeting-derived items including minutes of meetings, decisions, action items, tasks, risks, issues, assumptions, and dependencies.

In some embodiments, the system processes meeting content using an AI/NLP pipeline that includes optional preprocessing, segmentation, candidate detection, and confidence scoring to produce ranked candidate meeting-derived items and to support confidence-based auto-advance or human review workflows.

In some embodiments, when machine-readable meeting content is unavailable or incomplete, the system provides user interfaces that enable manual entry of meeting-derived items, which are stored in association with the corresponding meeting record.

In some embodiments, meeting-derived items are persistently associated with the originating meeting, and lineage metadata is stored to link each derived item to underlying meeting artifacts or transcript segments. In some embodiments, tasks are further associated with corresponding action items, enabling hierarchical traceability between meetings, decisions, action items, tasks, risks, issues, assumptions, and dependencies.

In some embodiments, meeting-derived artifacts such as minutes of meeting (MOM) are managed as governed documents that are independent of the lifecycle state of the corresponding meeting. Such documents may be associated with a document lifecycle status representing a governance workflow, including states such as Draft, Under Review, Approved, and Superseded or Obsolete, and may further support versioning such that multiple versions of a document may exist over time while preserving previously approved versions as immutable records.

In some embodiments, the system enforces closure conditions that restrict transition of a meeting to a closed state until one or more governance conditions are satisfied, such as approval of meeting minutes, resolution of associated action items or risks, or satisfaction of a policy rule.

In some embodiments, the system generates dashboards and analytics that aggregate data across a plurality of meetings and meeting-derived items and supports role-based views across multiple organizational hierarchy levels including organization-level, department-level, team-level, and individual-level views, including views for executive leadership and governance roles.

In some embodiments, the system enforces role-based governance controls that regulate visibility and interaction with meetings and meeting-derived items based on organizational roles, hierarchy levels, and policy rules, and maintains audit trails that capture lifecycle events and changes associated with such records for traceability and accountability.

In some embodiments, the system supports selective visibility designation for meeting-derived items. An owner of an action item, task, risk, or issue may designate one or more organizational recipients or scopes for visibility of the item, thereby signaling elevated importance without altering execution ownership or responsibility.

In some embodiments, the system applies security and privacy controls including encryption at rest, tenant-based partitioning, and redaction or anonymization of meeting content prior to downstream processing, analytics generation, or presentation.

In some embodiments, risks and issues identified from meeting content are assigned ownership, tracked across lifecycle states, and linked to enterprise risk management (ERM) frameworks, including association with risk registers, risk categories, and escalation rules.

In some embodiments, the system provides closed-loop execution tracking by correlating meeting outcomes with task completion, risk resolution, and formal meeting closure, thereby enabling verification that decisions and commitments made during meetings are executed and resolved.

In some embodiments, the system exposes meeting and governance data through reports or interfaces for integration with external analytics, reporting, business intelligence systems, and external execution or workflow management systems.

In some embodiments, the system classifies one or more meeting-derived action items or tasks as repetitive or recurring organizational actions based on recurrence criteria including temporal schedules, event-based triggers, policy requirements, regulatory obligations, historical repetition patterns, or user designation.

In some embodiments, repetitive or recurring organizational actions are maintained as persistent governed action entities that remain active across multiple execution intervals, each persistent action entity being associated with one or more execution cycles corresponding to successive recurrence periods.

In some embodiments, for each persistent action entity, the system automatically generates discrete execution cycle records corresponding to defined recurrence intervals, each execution cycle being independently tracked, monitored, and evaluated with respect to execution status, completion timeliness, ownership accountability, and compliance with defined organizational, policy, or regulatory criteria.

In some embodiments, the system continuously monitors execution cycles of repetitive actions and generates monitoring events including alerts, reminders, or escalation triggers based on predefined thresholds, grace periods, or service-level criteria, wherein delayed or missed execution cycles result in hierarchical notifications or escalations to designated management or governance roles.

In some embodiments, execution failures, repeated delays, or non-compliance associated with repetitive action execution cycles result in creation or update of corresponding risks or issues, which are linked to the originating persistent action entity and, where applicable, to related meetings, thereby enabling enterprise-level visibility into recurring execution failures and compliance risks.

In some embodiments, the system maintains auditable historical records of execution cycles for repetitive actions, including completion outcomes, delays, escalations, and associated risks or issues, thereby enabling longitudinal analysis of execution patterns, compliance trends, and organizational accountability across repeated execution intervals.

### BRIEF DESCRIPTION OF THE DRAWINGS

FIG. 1 is a block diagram illustrating an example architecture of a computer-implemented unified meetings and project management system (UMS) (100), including user devices (110), a UMS application (120), authentication and role-based access control service (122), connector/API gateway (130), meeting sources (140), raw artifact store (150), transcription and normalization engine (160), canonical meeting artifacts (165), AI/NLP extraction pipeline (180) generating meeting-derived items (185), review and submission interface (190), centralized data store (200) supporting submitted objects (205), audit trail versions (210), lineage metadata (215), analytics engine (220), dashboard and reporting UI (230), optional BI export interface (240), and business intelligence engine (250).

FIG. 2 is a diagram illustrating an ingestion and normalization process including canonical schema mapping in which meeting event data from one or more meeting sources, such as platform A event data (310), platform B event data (320), and organization repository data (330) are ingested and processed by a normalization engine (340). The normalization engine (340) applies schema mapping, field alignment, and data transformation operations, and cooperates with identifier resolution and deduplication (360) to reconcile multiple identifiers and eliminate duplicate representations of the same meeting and generate a canonical meeting artifact object (350) that represents a unified and normalized representation of a meeting for downstream governance, lifecycle management, analytics, and execution tracking.

FIG. 3 is a diagram illustrating an example lifecycle state management model for a meeting entity (300). In the illustrated embodiment, a meeting transitions through a plurality of lifecycle states including Draft (310), Scheduled (320), Conducted (330), Reviewed (340), Published (350), and Closed (360).

FIG. 4 is a flow diagram illustrating an example artificial intelligence (AI) and natural language processing (NLP) pipeline (400) for processing canonical transcript data (410), including optional preprocessing (420), segmentation (430), candidate detection (440), confidence scoring (450), and submission (460) of meeting-derived items for storage in a centralized data store (470).

FIG. 5 is a diagram illustrating an example organizer review, document lifecycle governance, versioning, audit trail, and submission workflow for meeting-derived artifacts, such as minutes of meetings (MOM), including a working version and one or more released versions and retention of approved versions as immutable records.

FIG. 6 is a diagram illustrating an example analytics and insight generation process within the unified meeting management system, including generation of productivity indicators, trend data, and optimization recommendations.

FIG. 7 is a block diagram illustrating an example security, privacy, and access control architecture for the unified meeting management system, including encryption at rest, tenant-based partitioning, optional redaction and anonymization, and role-based access control (RBAC) filtering for hierarchical dashboard views.

FIG. 8 is a diagram illustrating an example repetitive or recurring action governance model in which a persistent repetitive action entity generates a plurality of execution cycles corresponding to successive recurrence periods.

FIG. 9 is a flow diagram illustrating an example cycle-based monitoring and escalation workflow for repetitive organizational actions, including execution cycle states and monitoring events producing notifications and escalations.

FIG. 10 is a diagram illustrating an example linkage between repetitive action execution cycles and enterprise risk and issue management in which execution failures result in creation or update of risks or issues linked to a repetitive action entity and optionally to related meetings.

FIG. 11 is a diagram illustrating an example dashboard and analytics view for repetitive or recurring organizational actions, including compliance status indicators, escalation events, and associated risks or issues.

### DETAILED DESCRIPTION OF THE INVENTION

The following description is provided to enable a person having ordinary skill in the art to make and use the disclosed embodiments. The described embodiments are examples and are not intended to be limiting; modifications and variations will be apparent to those skilled in the art.

Unless otherwise indicated, “or” and “and/or” are inclusive, and “based on” means “based at least in part on.” Functional components such as modules, services, and engines may be implemented in hardware, software, firmware, or any combination thereof. Unless otherwise indicated, a “meeting-derived item” includes at least one of minutes of meeting, decision, action item, task, risk, issue, dependency, or assumption.

### System Overview

In some embodiments, the Unified Meeting Suite (UMS) comprises a computer-implemented system configured to obtain, normalize, store, govern, and analyze meetings and meeting-derived information across an organization. The UMS may be implemented as a web-based application, a mobile application, a desktop application, or any combination thereof, and may be accessible to users through one or more user devices including desktop computers, laptops, tablets, or mobile devices.

In some embodiments, the UMS provides one or more user interfaces configured to support meeting scheduling, meeting participation, meeting monitoring, review of meeting outcomes, and follow-up tracking. The user interfaces may be role-based and configured to present different functionality and visibility based on organizational roles.

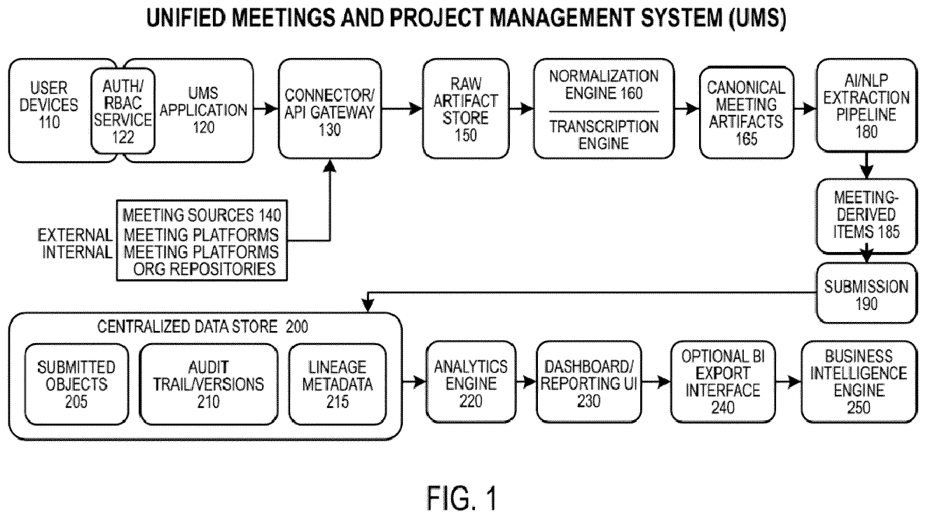

FIG. 1 illustrates one example architecture. In some embodiments, a connector/API gateway obtains meeting data from meeting sources including external meeting platforms, internal meeting platforms implemented within the system, calendaring systems, and organizational repositories. In some embodiments, the system stores raw artifacts (for example, audio, video, and transcript payloads) in a raw artifact store and transforms ingested information into canonical meeting artifacts for downstream governance, analytics, and execution tracking.

In some embodiments, the centralized data store supports storage and indexing of meeting records, meeting-derived items, document versions, audit trail versions, and lineage metadata. The centralized data store may be implemented as one or more databases and may support indexing, querying, and filtering based on at least one of a meeting identifier, organizer, meeting title, start and end date and time, meeting type, meeting status, participant identifiers, department, team, program, project, and other organizational hierarchy attributes.

In some embodiments, an analytics engine computes aggregates and generates dashboards and reports, and an export interface provides reporting data to external business intelligence systems. In some embodiments, the UMS also maintains persistent associations between meeting records and external system records to preserve traceability between meeting discussions and downstream execution activities.

### Meeting Ingestion and Canonicalization

In some embodiments, the UMS obtains meeting event data from one or more meeting sources. The meeting event data may include attributes such as a meeting identifier, organizer, meeting title, organizational context (for example, department, team, program, or project), start and end date and time, meeting location, meeting type, meeting category or sub-category, meeting priority, meeting status, participant identifiers, agenda information, transcript data when available, recurrence information, and access links.

In some embodiments, the UMS ingests meeting data via one or more connectors that are configured for specific meeting sources. The connectors may perform authentication, rate limiting, normalization of timestamps, retrieval of raw artifacts, and mapping of source-specific identifiers to internal identifiers.

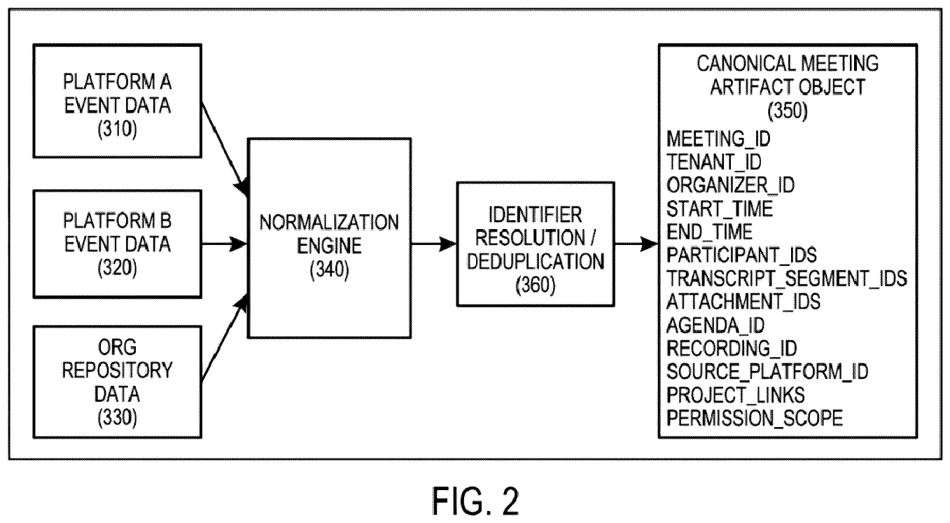

FIG. 2 illustrates an example ingestion and normalization process. In some embodiments, a normalization engine applies schema mapping, field alignment, and data transformation operations across heterogeneous meeting source schemas, and cooperates with an identifier resolution and deduplication component to reconcile multiple identifiers and eliminate duplicate representations of the same meeting. The output is a canonical meeting artifact object that represents a unified and normalized representation of a meeting for downstream governance, lifecycle management, analytics, and execution tracking.

In some embodiments, the identifier resolution and deduplication component uses one or more matching techniques including deterministic matching (for example, matching on meeting URL, calendar event identifier, and timestamp ranges), probabilistic matching (for example, fuzzy matching of titles and participant sets), and policy rules to select an authoritative representation when conflicts are detected. In some embodiments, a resolution decision is itself stored as auditable metadata.

In some embodiments, the canonical meeting artifact object conforms to a canonical schema including normalized fields for meeting metadata, participants, agenda items, transcript segments, and raw artifact references. In some embodiments, the canonical meeting artifact object includes a mapping table that preserves source-to-canonical field mappings to facilitate auditability and explainability of the transformation.

### Meeting Lifecycle Governance

In some embodiments, each meeting managed by the UMS is associated with one or more meeting lifecycle states. Example lifecycle states include Draft, Scheduled, Conducted, Reviewed, Published, and Closed.

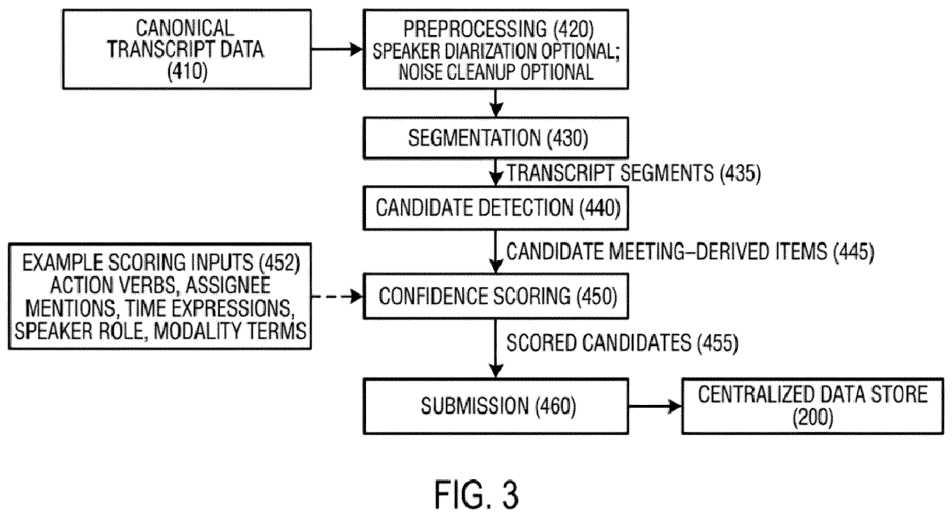

FIG. 3 illustrates one example lifecycle model. In some embodiments, meeting lifecycle state transitions are triggered by system events, user actions, calendaring updates, availability of meeting content, and/or organizational policy rules. In some embodiments, a meeting transitions from Scheduled to Conducted upon occurrence of the meeting, and transitions from Conducted to Reviewed upon availability of transcript data or other meeting content.

In some embodiments, the UMS enforces lifecycle-based governance rules. For example, the UMS may restrict closure of a meeting until one or more closure conditions are satisfied, such as approval of minutes of meeting and resolution or assignment of associated action items, risks, and issues.

In some embodiments, the lifecycle state of a meeting, the document lifecycle state of minutes of meeting, and the lifecycle states of execution items such as tasks, risks, or issues are maintained independently. Transitions in one lifecycle do not require or imply transitions in another lifecycle unless explicitly defined by organizational policy.

### AI and NLP Extraction of Meeting-Derived Items

In some embodiments, the UMS determines whether transcript data is available for a meeting. Transcript data may be generated by an internal transcription engine or may be received from an external meeting platform or service and incorporated into the canonical meeting artifact object.

In response to determining that transcript data is available, the UMS may process the transcript data using natural language processing (NLP) techniques to identify one or more meeting-derived items. Example meeting-derived items include minutes of meeting, decisions, action items, tasks, issues, risks, assumptions, dependencies, and discussion points.

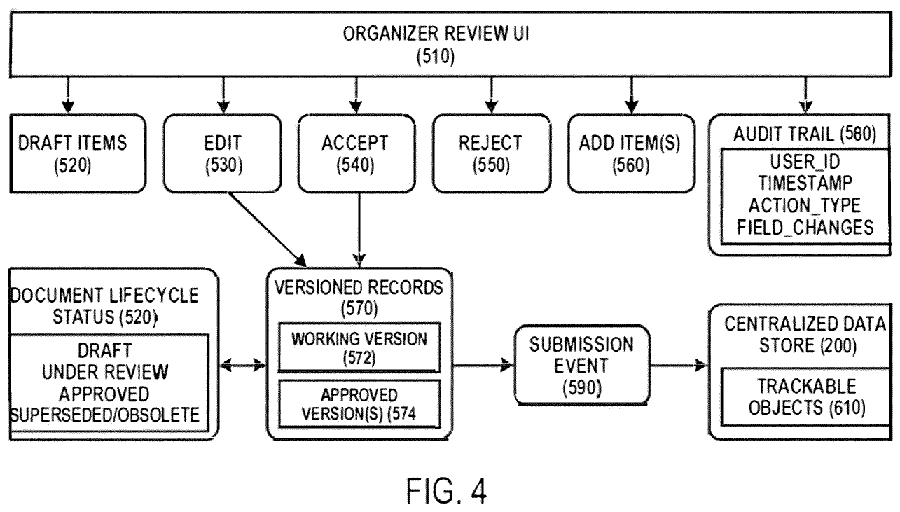

FIG. 4 illustrates one example AI/NLP pipeline. In some embodiments, the pipeline includes optional preprocessing such as speaker diarization, language detection, and noise cleanup. In some embodiments, the transcript data is segmented into transcript segments that are processed to identify candidate items.

In some embodiments, identifying meeting-derived items includes detecting candidate item text segments and extracting one or more structured fields such as an assignee, a due date, a priority, a category, and a status. In some embodiments, the UMS computes confidence values for candidate items and uses the confidence values to rank, filter, or flag items for human review.

In some embodiments, confidence scoring is performed based on one or more scoring inputs including linguistic features, contextual indicators, speaker roles, temporal expressions, and modality terms. In some embodiments, the UMS stores the confidence values and the scoring inputs as explainability metadata to support auditing of automated extraction.

In some embodiments, when confidence values satisfy a configurable threshold, the UMS automatically advances one or more candidate items to submission and storage. In other embodiments, candidate items are presented to an organizer or delegate for acceptance, editing, or rejection prior to submission.

### Manual Entry, Review, and Minutes of Meeting Governance

In some embodiments, the UMS supports manual entry of meeting-derived items. When transcript data is unavailable or incomplete, the UMS may present a transcript-unavailable indicator and a manual item entry interface.

In some embodiments, manually entered items are validated and stored in association with the corresponding meeting record, preserving consistency between automated and manual workflows.

In some embodiments, the UMS presents a user interface that allows a user to review meeting-derived items, edit fields of meeting-derived items, assign owners, set due dates, and update item status.

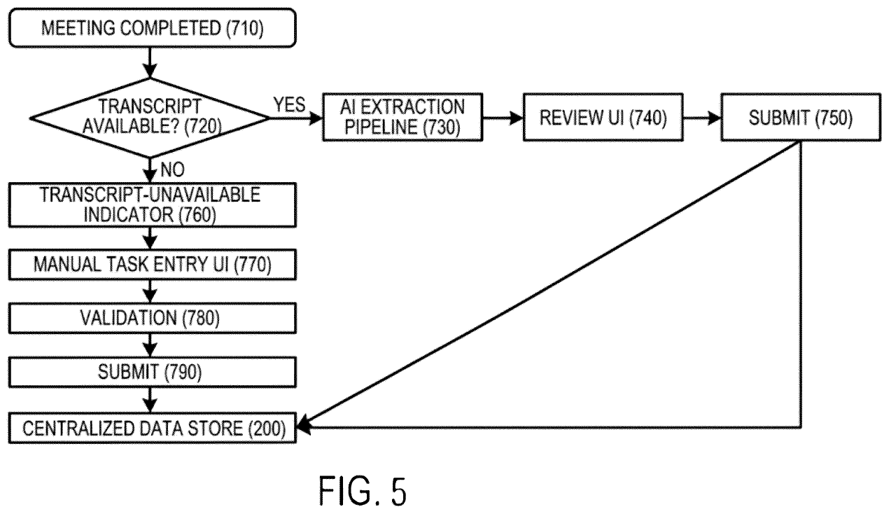

FIG. 5 illustrates an example organizer review and submission workflow. In some embodiments, draft meeting-derived artifacts, which may be generated automatically by one or more artificial intelligence processes or entered manually, are made available via an organizer review user interface. Through the organizer review user interface, an organizer or authorized delegate may edit, accept, reject, or add one or more additional artifacts manually.

In some embodiments, each action performed through the organizer review user interface results in updates to versioned records, which may include a working version and one or more released versions. In some embodiments, actions taken during organizer review are recorded in an audit trail that captures audit metadata including user identifiers, timestamps, action types, document status changes, and field-level modifications.

In some embodiments, minutes of meeting (MOM) are managed as governed documents that are distinct from the lifecycle state of the corresponding meeting and distinct from execution item lifecycles. In some embodiments, a MOM document is associated with a document lifecycle status representing a governance workflow including Draft, Under Review, Approved, and Superseded or Obsolete.

In some embodiments, approval of a MOM document results in the creation of an approved version that is retained as an immutable record. Subsequent changes may result in creation of a new draft version without altering the previously approved version, which may be marked as superseded or obsolete.

In some embodiments, organizer review is optional and may be bypassed based on organizational configuration, policy rules, meeting type, or confidence thresholds associated with automatically generated artifacts, such that artifacts may be automatically advanced to submission without organizer intervention.

### Persistent Lineage, Execution Tracking, and Closure Enforcement

In some embodiments, each meeting-derived item maintains a persistent association with the originating meeting. In some embodiments, tasks are further associated with corresponding action items, thereby preserving lineage between meetings, decisions, action items, tasks, risks, and issues.

In some embodiments, lineage metadata links each stored meeting-derived item to at least one underlying portion of the canonical meeting artifact object, such as a transcript segment identifier, a timestamp range, a speaker identifier, or a raw artifact reference. This lineage metadata enables traceability of execution back to the meeting context in which commitments, decisions, issues, or risks were identified.

In some embodiments, the UMS supports monitoring and follow-up by providing lists of open items, overdue items, completed items, and unresolved items for selected organizational scopes and time ranges.

In some embodiments, the UMS identifies unresolved meeting outcomes based on the presence of open action items, unapproved minutes, unresolved issues, open risks, or incomplete decisions. In some embodiments, unresolved outcomes may prevent closure of the meeting, trigger notifications, or be escalated according to organizational policies.

### Selective Visibility Signaling

In large organizations, the volume of meetings and meeting-derived items may be substantial, and leadership may not require visibility into all such items.

In some embodiments, the UMS supports selective visibility designation for meeting-derived items. An owner of an action item, task, risk, or issue may designate one or more organizational recipients or scopes for visibility of the item. Designated visibility scopes may include a specific individual, a leadership role, a management group, a department, a business unit, or an organizational level.

In some embodiments, the visibility designation serves as an intentional signal indicating elevated importance, business impact, decision relevance, or risk significance, without altering execution ownership or responsibility.

In some embodiments, the UMS uses visibility designations to control presentation, prioritization, or emphasis of items in dashboards, summaries, and notifications, such that leadership views highlight items explicitly flagged for management awareness. In some embodiments, visibility designations may be modified over time as urgency, impact, or status changes.

### Dashboards, Analytics, and Optimization

In some embodiments, the UMS generates dashboard data that aggregates metrics across meetings. Example aggregated metrics include meeting counts, meeting time aggregates, attendance metrics, and status-based counts for meeting-derived items including open, overdue, completed, or resolved action items, tasks, risks, and issues.

In some embodiments, the UMS supports dashboards at multiple organizational hierarchy levels, including an organization level, a department level, a team level, and an individual level. In some embodiments, an executive dashboard presents organization-level metrics and selectively emphasized items based on visibility designations.

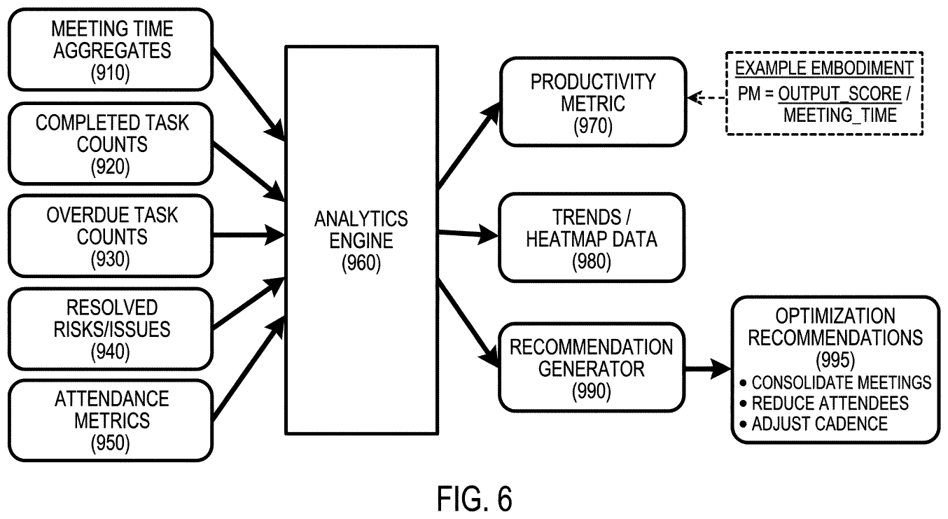

FIG. 6 illustrates an example analytics and insight generation process. In some embodiments, aggregated meeting-related data is provided as inputs to an analytics engine that generates productivity indicators, trend and heatmap data, and optimization recommendations. In some embodiments, productivity indicators represent normalized or ratio-based measures derived from meeting participation and execution outcomes without assuming a direct causal relationship between time spent in meetings and execution of work.

In some embodiments, the UMS performs historical and cross-meeting analysis to identify repeated meetings, persistent issues, execution bottlenecks, or compliance trends across time periods and organizational scopes.

In some embodiments, the UMS generates optimization recommendations to consolidate meetings, adjust meeting cadence, modify participant lists, and improve follow-through on meeting-derived actions.

### Security, Privacy, and Role-Based Access Control

In some embodiments, the UMS enforces role-based access control (RBAC) for access to meeting data, meeting-derived items, and dashboards. Access permissions may be defined based on organizational roles, hierarchy levels, teams, departments, and other governance policies.

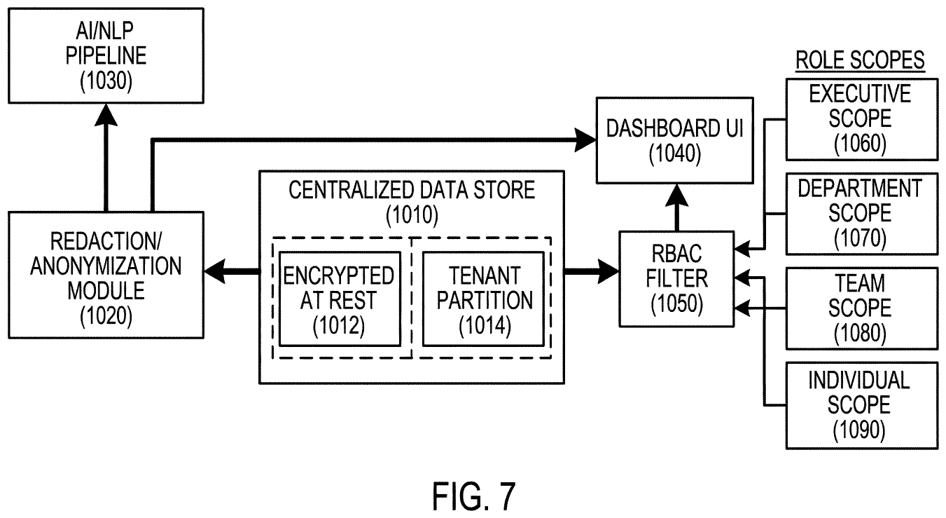

FIG. 7 illustrates one example security, privacy, and access control architecture. In some embodiments, meeting data and meeting-derived artifacts are stored in a centralized data store that includes encryption at rest and tenant-based partitioning to ensure isolation between organizational tenants.

In some embodiments, a redaction and anonymization module is applied to meeting content, transcripts, or meeting-derived artifacts to remove, mask, or obfuscate sensitive information prior to downstream processing, analytics generation, export, or presentation.

In some embodiments, access to meeting data and analytics outputs is governed by an RBAC filter that enforces visibility and access permissions based on user roles, organizational hierarchy, policy rules, and contextual constraints. In some embodiments, filtered data is presented through dashboards supporting scoped views corresponding to an executive scope, a department scope, a team scope, and an individual scope.

### Enterprise Risk Management and External System Integrations

In some embodiments, risks and issues identified from meeting content are integrated with enterprise risk management (ERM) frameworks. Such integration may include associating meeting-derived risks or issues with enterprise risk registers, risk categories, impact levels, likelihood assessments, mitigation plans, and escalation policies.

In some embodiments, meeting-derived risks are assigned ownership and tracked across lifecycle states independently of meeting closure and may be escalated to organizational risk governance bodies based on severity, persistence, or visibility designation.

In some embodiments, the UMS integrates with one or more external execution or workflow management systems, including project management systems, task management systems, customer relationship management (CRM) systems, ticketing systems, and information technology service management (ITSM) systems. In some embodiments, integrations are performed through application programming interfaces (APIs), connectors, event-based mechanisms, or data exchange interfaces, and may support one-way or bi-directional synchronization.

In some embodiments, the UMS maintains persistent associations between meeting records and external system records to preserve traceability between meeting discussions and downstream execution activities across integrated systems.

In some embodiments, the UMS provides reporting data to external business intelligence tools through an export interface and may support generation of reports viewable within the UMS application.

### AI-Assisted Organizational Meeting Intelligence

In some embodiments, the UMS includes one or more artificial intelligence (AI) models configured to operate on a centralized repository of meetings and meeting-derived information accumulated across an organization.

In some embodiments, the AI models analyze historical and current meeting records, lifecycle states, meeting-derived items, organizational hierarchy attributes, and visibility designations to provide organization-wide assistance.

In some embodiments, the AI models generate responses to role-specific or governance-oriented natural language queries based on the centralized data store. For example, an executive user may request identification or summarization of meetings, decisions, action items, risks, or issues that are pending, unresolved, overdue, or flagged for leadership visibility within a defined organizational scope.

In some embodiments, AI-assisted outputs include summaries, explanations, or contextual views that are filtered based on lifecycle state, organizational role, hierarchy level, ownership, and/or visibility designation, and include references to underlying meeting records and associated meeting-derived items.

In some embodiments, the AI models are trained, refined, or adapted using organization-specific meeting data stored in the centralized data store, thereby enabling contextualized responses that reflect organizational practices, terminology, and governance structure.

In some embodiments, AI-assisted processing augments, but does not replace, human governance, review, or decision-making, and the UMS supports fallback to non-AI or rule-based mechanisms when AI-assisted functionality is unavailable.

### Repetitive and Recurring Action Governance

In some embodiments, the UMS determines whether one or more meeting-derived action items or tasks represent repetitive or recurring organizational actions. Such determination may be based on recurrence indicators including explicit recurrence rules, temporal schedules, event-based triggers, policy requirements, regulatory obligations, historical repetition patterns, and/or user designation.

In some embodiments, action items classified as repetitive or recurring are managed as persistent governed action entities that remain active across multiple execution intervals, rather than being closed upon completion of a single occurrence. Each persistent repetitive action entity represents an ongoing organizational commitment and is maintained independently of individual meetings or individual execution instances.

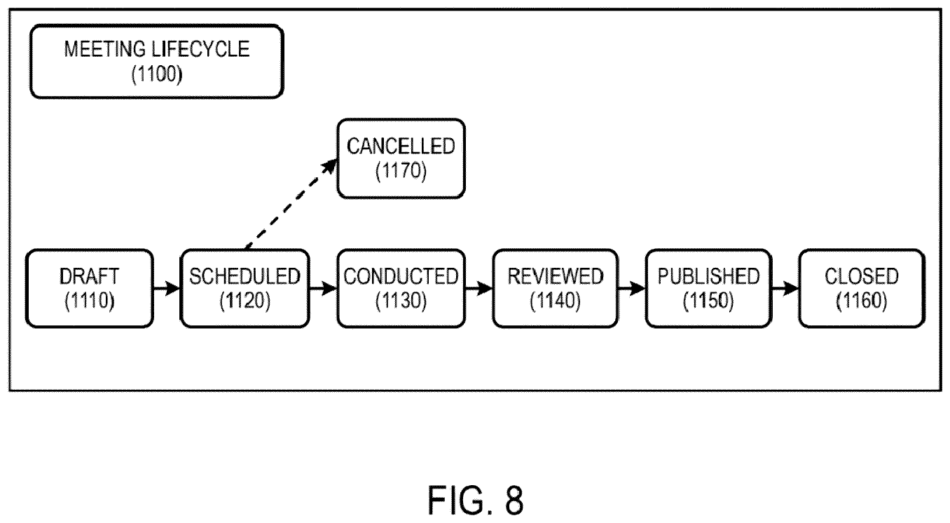

FIG. 8 illustrates an example repetitive action governance model. In some embodiments, a persistent repetitive action entity generates a plurality of execution cycle records corresponding to successive recurrence periods, wherein each execution cycle represents a discrete instance of the recurring organizational action.

In some embodiments, each execution cycle associated with a repetitive action entity is managed through one or more lifecycle states including pending, in-progress, completed, delayed, or missed. Lifecycle state transitions may occur based on user actions, system-detected conditions, elapsed time thresholds, or policy-defined rules.

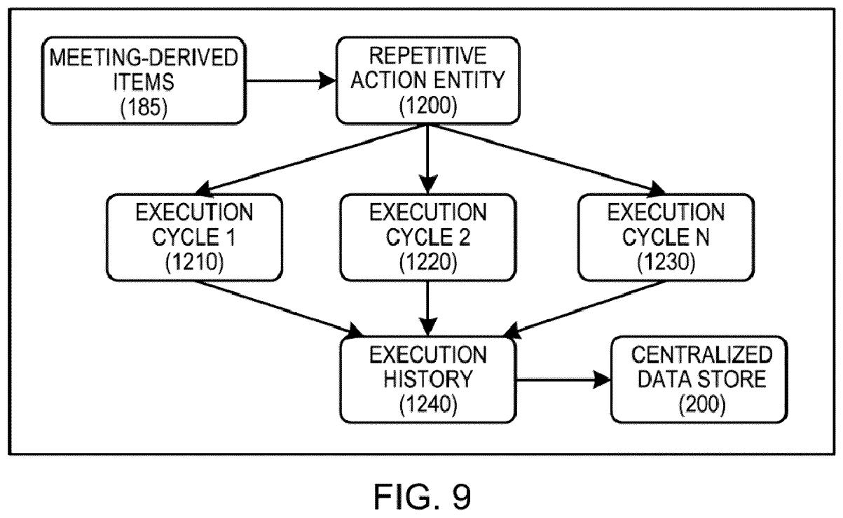

FIG. 9 illustrates an example cycle-based monitoring and escalation workflow. In some embodiments, the UMS continuously monitors execution cycles and generates monitoring events including alerts, reminders, and escalation triggers based on predefined thresholds, grace periods, service-level criteria, or compliance rules. Delayed or missed execution cycles may result in hierarchical notifications or escalations to designated management, governance, or compliance roles.

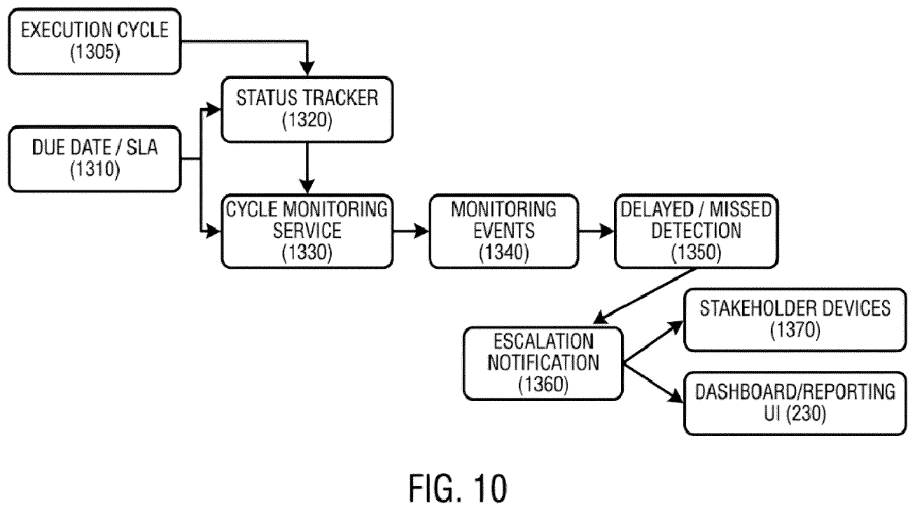

FIG. 10 illustrates an example linkage between repetitive action execution cycles and enterprise risk and issue management. In some embodiments, execution failures, repeated delays, or non-compliance associated with one or more execution cycles result in creation or update of corresponding risks or issues. Such risks or issues may be persistently linked to the repetitive action entity and, where applicable, to one or more related meetings from which the repetitive action originated.

In some embodiments, the UMS maintains auditable historical records of execution cycles for repetitive action entities, including completion outcomes, delays, escalations, and associated risks or issues. Historical execution data enables longitudinal analysis of execution performance, identification of recurring non-compliance patterns, and assessment of organizational accountability over time.

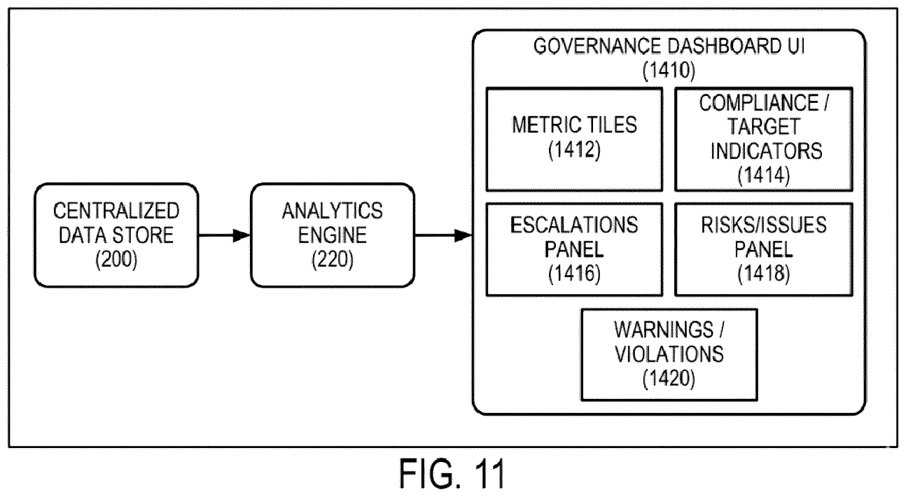

FIG. 11 illustrates an example dashboard and analytics view for repetitive or recurring organizational actions. In some embodiments, historical execution cycle data, compliance status indicators, escalation events, and associated risks or issues are aggregated and presented via governance dashboards to provide organizational leadership with visibility into recurring action performance, compliance trends, systemic execution bottlenecks, and organizational risk exposure across organizational scopes.

### System Architecture and Hardware Implementation

In some embodiments, the UMS is implemented using a service-oriented or microservices-based architecture to support scalability, reliability, and tenant isolation. In some embodiments, the connector gateway, normalization engine, transcription services, AI/NLP extraction services, analytics engine, and dashboard services are deployed as separate services that communicate via secure APIs.

In some embodiments, ingestion and processing are performed asynchronously using one or more message queues or event buses. For example, ingestion of raw meeting artifacts may generate an event that triggers transcription, normalization, extraction, and governance workflows, enabling horizontal scaling and backpressure control.

In some embodiments, the centralized data store includes one or more storage tiers, such as (i) an object store for raw artifacts and large transcript payloads, (ii) a structured database for canonical meeting artifacts and governed objects, and (iii) an append-only audit log for audit trail versions. In some embodiments, the system maintains immutability guarantees by writing approved records to write-once or append-only structures while permitting new versions to be created as separate records.

In some embodiments, the UMS maintains secondary indexes, search indexes, or materialized views that support role-scoped queries and dashboard aggregation. In some embodiments, the RBAC filter is applied at query time based on role scopes and organizational hierarchy attributes stored with meeting records and meeting-derived items.

In some embodiments, the system is implemented using one or more physical processors executing instructions stored in non-transitory computer-readable memory. The processors may include general-purpose processors and may be deployed on servers, containers, virtual machines, or cloud services. In some embodiments, the system uses hardware accelerators (for example, GPUs or NPUs) for transcription or AI/NLP inference.

In some embodiments, system components communicate over one or more networks using secure protocols, and the system uses authentication mechanisms to validate user identities and service identities. In some embodiments, the system enforces data retention and deletion policies, including retention of audit records and immutable approved document versions in accordance with organizational governance requirements.

### Organizational Hierarchy, Auditability, and Compliance

In some embodiments, the UMS represents an organization using a hierarchical governance model that defines relationships among organizational levels, roles, teams, departments, programs, projects, or business units. Meetings and meeting-derived items are associated with one or more organizational hierarchy attributes, enabling governance, visibility, and reporting to be scoped according to organizational structure.

In some embodiments, governance responsibilities are distinguished from execution ownership. For example, an executive or leadership role may have visibility into meeting outcomes, risks, or unresolved items without being assigned responsibility for execution.

In some embodiments, the UMS maintains audit records associated with meetings, meeting-derived items, minutes documents, and repetitive action cycles. Audit records may include creation events, modifications, approvals, assignments, status changes, visibility designations, access events, and closure actions. Audit records may be time-stamped and associated with user identifiers, roles, or system processes that performed the corresponding actions.

In some embodiments, traceability enables reconstruction of decision context, including identifying when a decision was discussed, who participated, what follow-up actions were agreed upon, and how those actions progressed over time. In some embodiments, audit and traceability data is retained in accordance with organizational or regulatory retention policies and is itself protected by role-based access control to ensure confidentiality and integrity.

What is claimed is:

1. A computer-implemented system for governance of organizational meetings comprising:
one or more processors; and
a non-transitory computer-readable memory storing instructions that, when executed by the one or more processors, cause the system to:
(a) obtain, via one or more connectors, meeting event data and meeting content for a meeting from one or more meeting sources;
(b) normalize the meeting event data into a canonical meeting artifact object by applying (i) schema mapping and field alignment across heterogeneous meeting source schemas and (ii) identifier resolution and deduplication to reconcile multiple identifiers for the meeting;
(c) store, in a centralized data store, a meeting record associated with a meeting identifier and comprising the canonical meeting artifact object;
(d) manage the meeting record according to a meeting lifecycle state machine that includes at least draft, scheduled, conducted, reviewed, published, and closed states;
(e) determine whether machine-readable transcript data for the meeting is available from the canonical meeting artifact object or a transcription service;
(f) in response to determining that the transcript data is available, process the transcript data using an artificial intelligence (AI) and natural language processing (NLP) pipeline that includes segmentation of the transcript data, candidate detection to identify candidate meeting-derived items, and confidence scoring of the candidate meeting-derived items;
(g) based on the confidence scoring, select one or more meeting-derived items and store the one or more meeting-derived items in the centralized data store in association with the meeting identifier;
(h) maintain, in the centralized data store, lineage metadata linking each stored meeting-derived item to at least one of (i) the meeting record and (ii) an underlying portion of the canonical meeting artifact object, and maintain audit records capturing at least edits and lifecycle state transitions of the meeting record and the meeting-derived items; and
(i) generate, for presentation via one or more user interfaces, one or more role-scoped dashboards or reports derived from the centralized data store by applying role-based access control (RBAC) filtering based on organizational hierarchy attributes associated with the meeting record and the meeting-derived items.

2. The system of claim 1, wherein the one or more meeting sources comprise at least one of: an external meeting platform, an internal meeting platform implemented within the system, a calendaring system, or an organizational repository.

3. The system of claim 1, wherein the canonical meeting artifact object conforms to a canonical schema that defines normalized fields for at least meeting metadata, participants, agenda, and transcript data, and wherein identifier resolution comprises deduplicating duplicate representations of the meeting received from multiple meeting sources.

4. The system of claim 1, wherein managing the meeting record comprises transitioning the meeting record between the meeting lifecycle states based on at least one of system events, user actions, calendaring updates, or policy rules, and wherein the meeting lifecycle state machine is maintained independently of a document lifecycle for minutes of meeting and independently of lifecycle states of execution items.

5. The system of claim 1, wherein the instructions further cause the system to restrict transition of the meeting record to the closed state until at least one closure condition is satisfied, the at least one closure condition comprising at least one of: approval of minutes of meeting for the meeting, resolution of one or more open meeting-derived items, or satisfaction of a policy rule.

6. The system of claim 1, wherein the AI and NLP pipeline comprises preprocessing of the transcript data including at least one of speaker diarization or noise cleanup prior to segmentation.

7. The system of claim 1, wherein confidence scoring is based on one or more scoring inputs comprising at least one of linguistic features, contextual indicators, speaker roles, temporal expressions, or modality terms, and wherein the one or more user interfaces present the candidate meeting-derived items as a ranked list based on confidence scores.

8. The system of claim 1, wherein the instructions further cause the system to, in response to determining that the transcript data is unavailable, present a transcript-unavailable indicator, receive manual entry of one or more meeting-derived items via a user interface, and store the manually entered meeting-derived items in association with the meeting identifier.

9. The system of claim 1, wherein at least one of the one or more meeting-derived items comprises minutes of meeting (MOM), and wherein the instructions further cause the system to manage the MOM as a governed document associated with a document lifecycle status that is independent of the meeting lifecycle state machine, the document lifecycle status comprising at least Draft, Under Review, Approved, and Superseded states, and wherein an approved version of the MOM is retained as an immutable record.

10. The system of claim 1, wherein the instructions further cause the system to receive, for a meeting-derived item, a selective visibility designation identifying a visibility scope, the selective visibility designation causing the meeting-derived item to be emphasized in at least one dashboard associated with the visibility scope without modifying ownership or execution responsibility for the meeting-derived item.

11. The system of claim 1, wherein the centralized data store enforces tenant-based partitioning and encryption at rest, and wherein the instructions further cause the system to apply a redaction or anonymization operation to at least one of transcript data or meeting-derived items prior to analytics generation, export, or dashboard presentation.

12. The system of claim 1, wherein the instructions further cause the system to (i) link at least one meeting-derived risk or issue to an enterprise risk management (ERM) system or risk register, and (ii) provide reporting data to an external business intelligence tool via an export interface while maintaining persistent associations between meeting records and external system records.

13. A computer-implemented system for governance of repetitive organizational actions comprising:
one or more processors; and
a non-transitory computer-readable memory storing instructions that, when executed by the one or more processors, cause the system to:
(a) maintain, in a centralized data store, a persistent repetitive action entity representing a repetitive organizational action and comprising a recurrence definition;
(b) generate, based on the recurrence definition, a plurality of execution cycle records, each execution cycle record corresponding to a successive recurrence period and comprising at least an execution status field;
(c) monitor the execution cycle records to detect at least one of a delayed execution cycle or a missed execution cycle based on at least one policy threshold, and in response generate at least one monitoring event comprising an alert or hierarchical escalation to at least one role scope;
(d) in response to detecting repeated delays or non-compliance associated with the execution cycle records, create or update at least one risk or issue record linked to the persistent repetitive action entity and, when available, linked to an originating meeting record; and
(e) generate, for presentation via a dashboard user interface, compliance analytics derived from historical execution cycle data for the persistent repetitive action entity.

14. The system of claim 13, wherein the recurrence definition is based on at least one of a temporal schedule, an event-based trigger, a policy requirement, a regulatory obligation, a historical repetition pattern, or a user designation.

15. The system of claim 13, wherein each execution cycle record comprises at least one of a due date, an assignee, or a compliance evaluation field, and wherein the execution status field indicates at least one of pending, in-progress, completed, delayed, or missed.

16. The system of claim 13, wherein monitoring comprises applying a grace period or service-level criterion to determine delayed or missed execution cycles and generating notifications in accordance with an escalation policy.

17. The system of claim 13, wherein the risk or issue record is integrated with an enterprise risk management system or risk register and includes at least one of a risk category, an impact level, a likelihood assessment, or a mitigation plan.

18. The system of claim 13, wherein the dashboard user interface applies role-based access control filtering such that an executive scope dashboard emphasizes repetitive action entities having at least one execution cycle record associated with a monitoring event or a risk or issue record.

19. The system of claim 13, wherein the system maintains an auditable history of execution cycle records including timestamps of status transitions and escalation actions, and wherein the auditable history is retained as immutable historical records.

20. A computer-implemented method for governance of organizational meetings comprising:
(a) obtaining, via one or more connectors, meeting event data and meeting content for a meeting from one or more meeting sources;
(b) normalizing the meeting event data by applying schema mapping and identifier resolution to generate a canonical meeting artifact object representing the meeting;
(c) storing, in a centralized data store, a meeting record associated with a meeting identifier and comprising the canonical meeting artifact object;
(d) managing the meeting record according to a meeting lifecycle state machine and recording lifecycle state transitions in an audit log;
(e) when machine-readable transcript data for the meeting is available, processing the transcript data using an AI and NLP pipeline comprising segmentation, candidate detection, and confidence scoring to select meeting-derived items;
(f) storing the meeting-derived items in association with the meeting identifier together with lineage metadata linking each meeting-derived item to at least one underlying transcript segment or other portion of the canonical meeting artifact object; and
(g) generating at least one role-scoped dashboard or response to a natural language query by applying role-based access control filtering to the centralized data store and outputting references to one or more underlying meeting records or meeting-derived items.
